(19) United States
(12) Patent Application Publication
(10) Pub. No.: US 2025/0119798 A1
(43) Pub. Date: Apr. 10, 2025

(54) NETWORK NODE, METHOD AND COMPUTER PROGRAM

(71) Applicant: Nokia Technologies Oy, Espoo (FI)

(72) Inventors: Samer BAZZI, Munich (DE); Mohammad SOLIMAN, Munich (DE); Guillaume DECARREAU, Munich (DE); Martin KOLLÁR, Kosice (SK)

(21) Appl. No.: 18/906,360

(22) Filed: Oct. 4, 2024

(30) Foreign Application Priority Data
Oct. 6, 2023 (WO) PCT/EP2023/077791

(51) Int. Cl. H04W 36/00

(52) U.S. Cl. CPC H04W 36/0055

(57) ABSTRACT

A network node for supporting providing radio coverage within one or more cells of a communication network. The network node is configured to, in response to receipt from a user equipment of an indication of a cell controlled by another network node, transmit to a central network node a request for an address for communication of the another network node. The network node is further configured to, in response to receipt from the central network node of the address for communication of the another network node, store the address for communication of the another network node in a datastore of the network node. The network node is further configured to, in response to receipt of an update on a status of the cell, update the datastore accordingly.

### TECHNOLOGICAL FIELD

Various example embodiments relate to a radio communication network and to ways of exchanging addresses for communication of network nodes.

### BACKGROUND

The configuration of active cells in cellular systems in a given geographical area may change. For example, events such as festivals may cause an influx of user equipment to a particular area. New cells may be created to manage the additional user load. These additional cells may be controlled by one or more gNodeBs (gNBs) that are different to the gNBs controlling the existing active cells. The number of active cells may also vary for energy saving purposes. For example, a cell may be switched off to conserve power when the user load is low and switched on when the user load is high.

From a gNB perspective, this may result in the number and identity of cells which neighbor the cells controlled by the gNB to change. The gNB may not have an established communication link to the new gNBs controlling the newly added cells. A way to establish a communication link between the gNBs is required.

### BRIEF SUMMARY

The scope of protection sought for various example embodiments of the disclosure is set out by the independent claims. The example embodiments and features, if any, described in this specification that do not fall under the scope of the independent claims are to be interpreted as examples useful for understanding various embodiments of the invention.

According to various, but not necessarily all, example embodiments of the disclosure there is provided a network node for supporting providing radio coverage within one or more cells of a communication network, said network node comprising: a datastore; at least one processor; and at least one memory storing instructions that when executed by the at least one processor cause the apparatus at least to perform: in response to receipt from a user equipment of an indication of a cell controlled by another network node, transmitting to a central network node a request for an address for communication of said another network node; in response to receipt from said central network node of said address for communication of said another network node, storing said address for communication of said another network node in said datastore; and in response to receipt of an update on a status of said cell, updating said datastore accordingly.

In some example embodiments, said updates on said status comprise an indication of a change to a status of said cell. For example, when said cell is activated and/or deactivated. When a cell is active, the cell provides radio coverage in a given geographical area for the communications network. When a cell is inactive, the cell no longer provides radio coverage within the communications network.

In some example embodiments, the network node comprises a gNB. In some example embodiments, the cell is controlled, including being activated and deactivated, by a central unit (CU) or distributed unit (DU) of a gNB.

In some example embodiments, said update of said status of said cell comprises an indication that said cell is no longer active.

In some example embodiments, said network node is further caused to perform: in response to receipt of said indication that said cell is no longer active, determining whether said another network node controls any other active cells which said network node is configured to receive updates on, and where not, said updating said datastore comprises removing said address for communication of said another network node from said datastore.

In some example embodiments, when said update of said status of said cell comprises an indication that said cell has been activated and in response to receipt of said address for communication of said another network node, said updating said datastore comprises storing said address for communication of said another network node in said datastore.

In some example embodiments, said update of said status of said cell is received from at least one of the following: said another network node and said central network node.

In some example embodiments, the network node is further caused to perform: in response to said receipt from said central network node of said address for communication of said another network node, transmitting to said another network node a request to receive updates on said status of said cell.

In some example embodiments, the network node is further caused to perform: in response to receipt from said user equipment of said indication of said cell controlled by said another network node, subscribing to receive updates on said status of said cell by transmitting to said central network node a request to receive updates on said status of said cell.

In some example embodiments, said request to receive updates and said request for said address for communication are comprised within the same transmission.

In some example embodiments, the network node is further caused to perform: causing receipt from said central network node of an acknowledgement of said subscribing.

In some example embodiments, the network node is further caused to perform: transmitting to said central network node a registration message comprising at least one of the following: an address for communication of said network node and a list of cells controlled by said network node.

In some example embodiments, said central network node comprises a network repository function.

In some example embodiments, said indication of said cell controlled by said another network node comprises a cell global identifier.

According to various, but not necessarily all, example embodiments of the disclosure there is provided a network node for supporting providing radio coverage within one or more cells of a communication network, said network node comprising: means for transmitting to a central network node a request for an address for communication of another network node in response to receipt from a user equipment of an indication of a cell controlled by said another network node; means for storing said address for communication of said another network node in a datastore of said network node in response to receipt from said central network node of said address for communication of said another network node; and means for updating said datastore accordingly in response to receipt of an update on a status of said cell.

The means may perform the optional features set out in relation to the apparatus mentioned above.

According to various, but not necessarily all, example embodiments of the disclosure there is provided a network node for supporting providing radio coverage within one or more cells of a communication network, said network node comprising: circuitry configured to perform, in response to receipt from a user equipment of an indication of a cell controlled by another network node, transmitting to a central network node a request for an address for communication of said another network node; circuitry configured to perform, in response to receipt from said central network node of said address for communication of said another network node, storing said address for communication of said another network node in a datastore of said network node; and circuitry configured to perform, in response to receipt of an update on a status of said cell, updating said datastore accordingly.

The circuitry may be configured perform the optional features set out in relation to the apparatus mentioned above.

According to various, but not necessarily all, example embodiments of the disclosure there is provided a network node for supporting providing radio coverage within one or more cells of a communication network, said network node comprising: at least one processor; and at least one memory storing instructions that when executed by the at least one processor cause the apparatus at least to perform: in response to a change to a status of a cell of said one or more cells, registering said change to said status by transmitting to a central network node an indication of said change.

In some example embodiments, further caused to perform: activating said cell; and, when said cell has been activated, said indication of said change comprises an indication that said cell has been activated.

In some example embodiments, the network node is further caused to perform: deactivating said cell; and, when said cell has been deactivated, said indication of said change comprises an indication that said cell has been deactivated.

In some example embodiments, the network node is further caused to perform: in response to receipt from another network node of a request for updates on a status of said cell, transmitting said indication of said change to said another network node.

In some example embodiments, the network node is further caused to perform: transmitting to said central network node a registration message comprising at least one of the following: an address for communication of said network node and a list of cells controlled by said network node.

In some example embodiments, the network node is further caused to perform; in response to said change to said status of said cell of said one or more cells, registering said change to said status by transmitting to a central network node a cell global identifier of said cell together with said indication of said change.

In some example embodiments, said central network node comprises a network repository function.

In some example embodiments, said network node comprises a gNB.

In some example embodiments, said network node comprises the features set out in relation to the network node above. In this way, there may be provided a network node configured to have the features of both of the example embodiments described above.

According to various, but not necessarily all, example embodiments of the disclosure there is provided a network node for supporting providing radio coverage within one or more cells of a communication network, said network node comprising: means for registering a change to a status of a cell of said one or more cells by transmitting to a central network node an indication of said change in response to said change to said status of said cell.

The means may perform the optional features set out in relation to the apparatus mentioned above.

According to various, but not necessarily all, example embodiments of the disclosure there is provided a network node for supporting providing radio coverage within one or more cells of a communication network, said network node comprising: circuitry configured to perform, in response to a change to a status of a cell of said one or more cells, registering said change to said status by transmitting to a central network node an indication of said change.

The circuitry may be configured perform the optional features set out in relation to the apparatus mentioned above.

According to various, but not necessarily all, example embodiments of the disclosure there is provided a central network node of a communication network, said central network node being configured to maintain a register of addresses for communication of network nodes within said communication network and a list of cells controlled by said network nodes within said communication network, said central network node comprising: a datastore comprising said register; at least one processor; and at least one memory storing instructions that when executed by the at least one processor cause the apparatus at least to perform: in response to receipt from a network node of a registration message comprising at least one of the following: an address for communication of a respective network node and a list of cells controlled by said network node, updating said register accordingly; and in response to receipt from a first network node of a request for an address for communication of a second network node controlling a cell of said communication network identified by said first network node, transmitting to said first network node an indication of said address for communication of said second network node.

In some example embodiments, said network node comprises at least one of the following: said first network node and said second network node.

In some example embodiments, the central network node is further caused to perform: in response to receipt from said second network node of an indication of a change to a status of said cell, updating said register accordingly.

In some example embodiments, said change comprises an activation of said cell and said updating said register comprises marking said cell as active.

In some example embodiments, said change comprises a deactivation of said cell and said updating said register comprises marking said cell as inactive.

In some example embodiments, the central network node is further caused to perform: in response to said receipt of said request for said address for communication, marking said first network node as having requested said address for communication of said second network node in said register and relaying to said first network node any indications of changes of said status of said cell received from said second network node.

In some example embodiments, the central network node is further caused to perform: in response to receipt from said second network node of a registration update message comprising an indication that said cell has been deactivated, transmitting to said first network node an indication that said cell is no longer active.

In some example embodiments, the central network node is further caused to perform: in response to receipt from said second network node of a registration update message comprising an indication that said cell has been activated, transmitting to said first network node an indication that said cell is active and an address for communication of said second network node.

In some example embodiments, the central network node is further caused to perform: in response to receipt from a network node of a request to receive updates on said status of said cell, transmitting an acknowledgement of said request to receive updates to said network node.

In some example embodiments, said central network node comprises a network repository function.

According to various, but not necessarily all, example embodiments of the disclosure there is provided a central network node of a communication network, said central network node being configured to maintain a register of addresses for communication of network nodes within said communication network and a list of cells controlled by said network nodes within said communication network, said central network node comprising: means for updating a register stored in a datastore of said network node in response to receipt from a network node of a registration message comprising at least one of the following: an address for communication of a respective network node and a list of cells controlled by said network node; and means for transmitting to a first network node an indication of said address for communication of a second network node in response to receipt from said first network node of a request for an address for communication of said second network node controlling a cell of said communication network identified by said first network node.

The means may perform the optional features set out in relation to the apparatus mentioned above.

According to various, but not necessarily all, example embodiments of the disclosure there is provided a central network node of a communication network, said central network node being configured to maintain a register of addresses for communication of network nodes within said communication network and a list of cells controlled by said network nodes within said communication network, said central network node comprising: circuitry configured to perform, in response to receipt from a network node of a registration message comprising at least one of the following: an address for communication of a respective network node and a list of cells controlled by said network node, updating said register accordingly; and circuitry configured to perform, in response to receipt from a first network node of a request for an address for communication of a second network node controlling a cell of said communication network identified by said first network node, transmitting to said first network node an indication of said address for communication of said second network node.

The circuitry may be configured perform the optional features set out in relation to the apparatus mentioned above.

According to various, but not necessarily all, example embodiments of the disclosure there is provided a method performed at a network node, said method comprising: in response to receipt from a user equipment of an indication of a cell controlled by another network node, transmitting to a central network node a request for an address for communication of said another network node; in response to receipt from said central network node of said address for communication of said another network node, storing said address for communication of said another network node in a datastore of said network node; and in response to receipt of an update on a status of said cell, updating said datastore accordingly.

In some example embodiments, the method further comprises: in response to said receipt from said central network node of said address for communication of said another network node, transmitting to said another network node a request to receive updates on said status of said cell.

In some example embodiments, the method further comprises: in response to receipt from said user equipment of said indication of said cell controlled by said another network node, subscribing to receive updates on said status of said cell by transmitting to said central network node a request to receive updates on said status of said cell.

In some example embodiments, the method further comprises: causing receipt from said central network node of an acknowledgement of said subscribing.

In some example embodiments, the method further comprises: transmitting to said central network node a registration message comprising at least one of the following: an address for communication of said network node and a list of cells controlled by said network node.

According to various, but not necessarily all, example embodiments of the disclosure there is provided a non-transitory computer readable medium comprising program instructions stored thereon for causing an apparatus to perform at least the following: in response to receipt from a user equipment of an indication of a cell controlled by another network node, transmitting to a central network node a request for an address for communication of said another network node; in response to receipt from said central network node of said address for communication of said another network node, storing said address for communication of said another network node in a datastore of said network node; and in response to receipt of an update on a status of said cell, updating said datastore accordingly.

The instructions may be for performing the optional features set out in relation to the method mentioned above.

According to various, but not necessarily all, example embodiments of the disclosure there is provided a computer program comprising instructions which when executed by a processor on a network node cause said network node to perform at least the following: in response to receipt from a user equipment of an indication of a cell controlled by another network node, transmitting to a central network node a request for an address for communication of said another network node; in response to receipt from said central network node of said address for communication of said another network node, storing said address for communication of said another network node in a datastore of said network node; and in response to receipt of an update on a status of said cell, updating said datastore accordingly.

The instructions may be for performing the optional features set out in relation to the method mentioned above.

According to various, but not necessarily all, example embodiments of the disclosure there is provided a method performed at a network node, said method comprising: in response to a change to a status of a cell controlled by said network node, registering said change to said status by transmitting to a central network node an indication of said change.

In some example embodiments, the method further comprises: activating said cell; and, when said cell has been activated, said indication of said change comprises an indication that said cell has been activated.

In some example embodiments, the method further comprises: deactivating said cell; and, when said cell has been deactivated, said indication of said change comprises an indication that said cell has been deactivated.

In some example embodiments, the method further comprises: in response to receipt from another network node of a request for updates on a status of said cell, transmitting said indication of said change to said another network node.

In some example embodiments, the method further comprises: transmitting to said central network node a registration message comprising at least one of the following: an address for communication of said network node and a list of cells controlled by said network node.

In some example embodiments, the method further comprises: in response to said change to said status of said cell of said one or more cells, registering said change to said status by transmitting to a central network node a cell global identifier of said cell together with said indication of said change.

According to various, but not necessarily all, example embodiments of the disclosure there is provided a non-transitory computer readable medium comprising program instructions stored thereon for causing an apparatus to perform at least the following: in response to a change to a status of a cell controlled by said network node, registering said change to said status by transmitting to a central network node an indication of said change.

The instructions may be for performing the optional features set out in relation to the method mentioned above.

According to various, but not necessarily all, example embodiments of the disclosure there is provided a computer program comprising instructions which when executed by a processor on a network node cause said network node to perform at least the following: in response to a change to a status of a cell controlled by said network node, registering said change to said status by transmitting to a central network node an indication of said change.

The instructions may be for performing the optional features set out in relation to the method mentioned above.

According to various, but not necessarily all, example embodiments of the disclosure there is provided a method performed at a central network node, said method comprising: in response to receipt from a network node of a registration message comprising at least one of the following: an address for communication of a respective network node and a list of cells controlled by said network node, updating a register maintained by said central network node of addresses for communication of network nodes and a list of cells controlled by said network nodes; and in response to receipt from a first network node of a request for an address for communication of a second network node controlling a cell of said communication network identified by said first network node, transmitting to said first network node an indication of said address for communication of said second network node.

In some example embodiments, the method further comprises: in response to receipt from said second network node of an indication of a change to a status of said cell, updating said register accordingly.

In some example embodiments, the method further comprises: in response to said receipt of said request for said address for communication, marking said first network node as having requested said address for communication of said second network node in said register and relaying to said first network node any indications of changes of said status of said cell received from said second network node.

In some example embodiments, the method further comprises: in response to receipt from said second network node of a registration update message comprising an indication that said cell has been deactivated, transmitting to said first network node an indication that said cell is no longer active.

In some example embodiments, the method further comprises: in response to receipt from said second network node of a registration update message comprising an indication that said cell has been activated, transmitting to said first network node an indication that said cell is active and an address for communication of said second network node.

In some example embodiments, the method further comprises: in response to receipt from a network node of a request to receive updates on said status of said cell, transmitting an acknowledgement of said request to receive updates to said network node.

According to various, but not necessarily all, example embodiments of the disclosure there is provided a non-transitory computer readable medium comprising program instructions stored thereon for causing an apparatus to perform at least the following: in response to receipt from a network node of a registration message comprising at least one of the following: an address for communication of a respective network node and a list of cells controlled by said network node, updating a register maintained by said central network node of addresses for communication of network nodes and a list of cells controlled by said network nodes; and in response to receipt from a first network node of a request for an address for communication of a second network node controlling a cell of said communication network identified by said first network node, transmitting to said first network node an indication of said address for communication of said second network node.

The instructions may be for performing the optional features set out in relation to the method mentioned above.

According to various, but not necessarily all, example embodiments of the disclosure there is provided a computer program comprising instructions which when executed by a processor on a network node cause said network node to perform at least the following: in response to receipt from a network node of a registration message comprising at least one of the following: an address for communication of a respective network node and a list of cells controlled by said network node, updating a register maintained by said central network node of addresses for communication of network nodes and a list of cells controlled by said network nodes; and in response to receipt from a first network node of a request for an address for communication of a second network node controlling a cell of said communication network identified by said first network node, transmitting to said first network node an indication of said address for communication of said second network node.

The instructions may be for performing the optional features set out in relation to the method mentioned above.

According to various, but not necessarily all, example embodiments of the disclosure there is provided a network node for supporting providing radio coverage within one or more cells of a communication network, said network node comprising: at least one processor; and at least one memory storing instructions that when executed by the at least one processor cause the network node at least to perform: in response to receipt from a central network node of a performance measurements request, transmitting to said central network node performance measurements for said one or more cells.

In some example embodiments, the network node is further caused to perform: causing receipt from said central network node of an address for communication of another network node controlling a cell neighbouring at least one of said one or more cells.

In some example embodiments, the network node is further caused to perform: activating a cell of said one or more cells.

In some example embodiments, said network node comprises a gNB.

According to various, but not necessarily all, example embodiments of the disclosure there is provided a network node for supporting providing radio coverage within one or more cells of a communication network, said network node comprising: means for transmitting to a central network node performance measurements for said one or more cells in response to receipt from said central network node of a performance measurements request.

The means may perform the optional features set out in relation to the apparatus mentioned above.

According to various, but not necessarily all, example embodiments of the disclosure there is provided a network node for supporting providing radio coverage within one or more cells of a communication network, said network node comprising: circuitry configured to perform, in response to receipt from a central network node of a performance measurements request, transmitting to said central network node performance measurements for said one or more cells.

The circuitry may be configured perform the optional features set out in relation to the apparatus mentioned above.

According to various, but not necessarily all, example embodiments of the disclosure there is provided a central network node of a communication network, comprising: at least one processor; and at least one memory storing instructions that when executed by the at least one processor cause the apparatus at least to perform: in response to receipt of performance measurements for a cell controlled by a network node within said communication network, determining other network nodes supporting providing radio coverage within one or more cells in the region of said cell; and transmitting a performance measurements request to at least one of said other network nodes; in response to receipt from said at least one of said other network nodes of performance measurements for said one or more cells, determining whether any of said one or more cells neighbour or overlap with said cell; and when it is determined that at least one cell of said one or more cells neighbours or overlaps with said cell, transmitting an address for communication of said network node to said at least one of said other network nodes.

In some example embodiments, said determining other network nodes supporting providing radio coverage within one or more cells in the region of said cell means determining which, if any, network nodes control cells that are in the same geographical area as said cell as these may be of interest for handover purposes.

In some example embodiments, said central network node comprises a network manager.

According to various, but not necessarily all, example embodiments of the disclosure there is provided a central network node of a communication network, comprising: means for determining other network nodes supporting providing radio coverage within one or more cells in the region of a cell controlled by a network node within said communication network in response to receipt of performance measurements for said cell controlled by said network node; means for transmitting a performance measurements request to at least one of said other network nodes; means for determining whether any of said one or more cells neighbour or overlap with said cell in response to receipt from said at least one of said other network nodes of performance measurements for said one or more cells; and means for transmitting an address for communication of said network node to said at least one of said other network nodes when it is determined that at least one cell of said one or more cells neighbours or overlaps with said cell.

The means may perform the optional features set out in relation to the apparatus mentioned above.

According to various, but not necessarily all, example embodiments of the disclosure there is provided a central network node of a communication network, comprising: circuitry configured to perform, in response to receipt of performance measurements for a cell controlled by a network node within said communication network, determining other network nodes supporting providing radio coverage within one or more cells in the region of said cell; circuitry configured to perform transmitting a performance measurements request to at least one of said other network nodes; circuitry configured to perform, in response to receipt from said at least one of said other network nodes of performance measurements for said one or more cells, determining whether any of said one or more cells neighbour or overlap with said cell; and circuitry configured to perform, when it is determined that at least one cell of said one or more cells neighbours or overlaps with said cell, transmitting an address for communication of said network node to said at least one of said other network nodes.

The circuitry may be configured perform the optional features set out in relation to the apparatus mentioned above.

According to various, but not necessarily all, example embodiments of the disclosure there is provided a method performed at a network node, said method comprising: in response to receipt from a central network node of a performance measurements request, transmitting to said central network node performance measurements for one or more cells controlled by said network node.

In some example embodiments, the method further comprises: causing receipt from said central network node of an address for communication of another network node controlling a cell neighbouring at least one of said one or more cells.

In some example embodiments, the method further comprises: activating a cell of said one or more cells.

According to various, but not necessarily all, example embodiments of the disclosure there is provided a non-transitory computer readable medium comprising program instructions stored thereon for causing an apparatus to perform at least the following: in response to receipt from a central network node of a performance measurements request, transmitting to said central network node performance measurements for one or more cells controlled by said network node.

The instructions may be for performing the optional features set out in relation to the method mentioned above.

According to various, but not necessarily all, example embodiments of the disclosure there is provided a computer program comprising instructions which when executed by a processor on a network node cause said network node to perform at least the following: in response to receipt from a central network node of a performance measurements request, transmitting to said central network node performance measurements for one or more cells controlled by said network node.

The instructions may be for performing the optional features set out in relation to the method mentioned above.

According to various, but not necessarily all, example embodiments of the disclosure there is provided a method performed at a central network node, said method comprising: in response to receipt of performance measurements for a cell controlled by a network node, determining other network nodes supporting providing radio coverage within one or more cells in the region of said cell; and transmitting a performance measurements request to at least one of said other network nodes; in response to receipt from said at least one of said other network nodes of performance measurements for said one or more cells, determining whether any of said one or more cells neighbour or overlap with said cell; and when it is determined that at least one cell of said one or more cells neighbours or overlaps with said cell, transmitting an address for communication of said network node to said at least one of said other network nodes.

According to various, but not necessarily all, example embodiments of the disclosure there is provided a non-transitory computer readable medium comprising program instructions stored thereon for causing an apparatus to perform at least the following: in response to receipt of performance measurements for a cell controlled by a network node, determining other network nodes supporting providing radio coverage within one or more cells in the region of said cell; and transmitting a performance measurements request to at least one of said other network nodes; in response to receipt from said at least one of said other network nodes of performance measurements for said one or more cells, determining whether any of said one or more cells neighbour or overlap with said cell; and when it is determined that at least one cell of said one or more cells neighbours or overlaps with said cell, transmitting an address for communication of said network node to said at least one of said other network nodes.

The instructions may be for performing the optional features set out in relation to the method mentioned above.

According to various, but not necessarily all, example embodiments of the disclosure there is provided a computer program comprising instructions which when executed by a processor on a network node cause said network node to perform at least the following: in response to receipt of performance measurements for a cell controlled by a network node, determining other network nodes supporting providing radio coverage within one or more cells in the region of said cell; and transmitting a performance measurements request to at least one of said other network nodes; in response to receipt from said at least one of said other network nodes of performance measurements for said one or more cells, determining whether any of said one or more cells neighbour or overlap with said cell; and when it is determined that at least one cell of said one or more cells neighbours or overlaps with said cell, transmitting an address for communication of said network node to said at least one of said other network nodes.

The instructions may be for performing the optional features set out in relation to the method mentioned above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

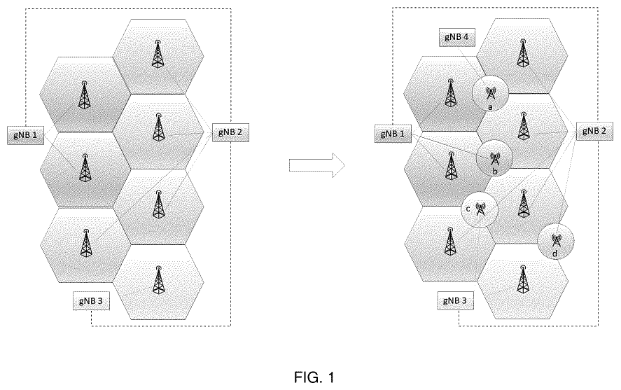

FIG. 1 illustrates the addition of cells to a cellular radio communications system according to an example embodiment;

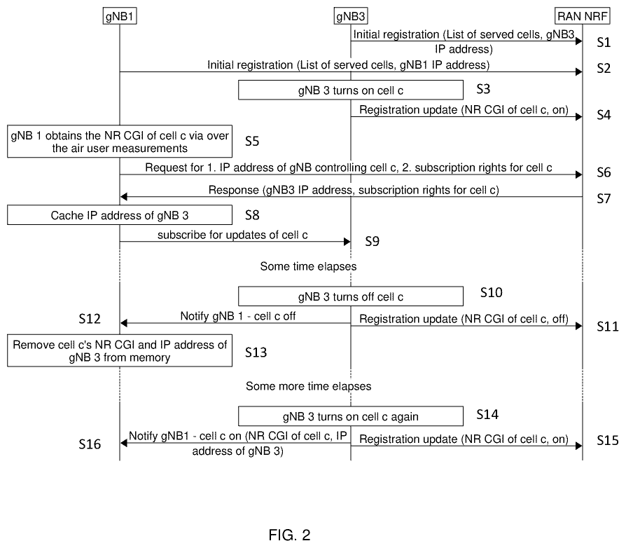

FIG. 2 illustrates a signalling diagram according to an example embodiment;

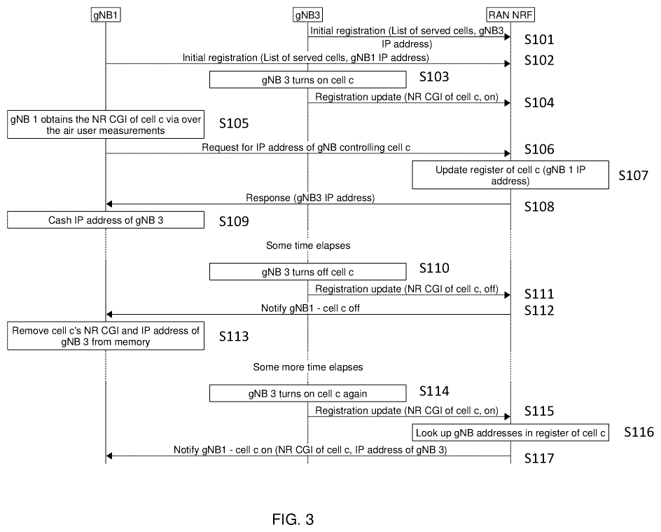

FIG. 3 illustrates a signalling diagram according to another example embodiment;

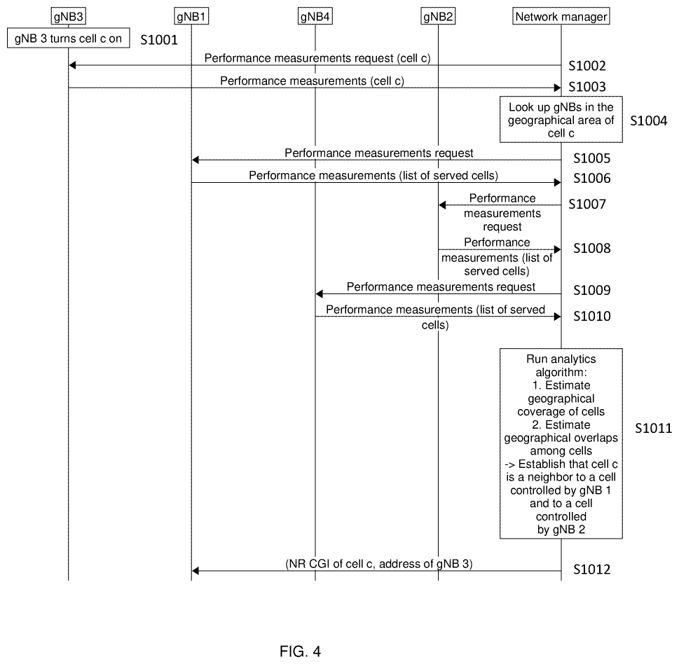

FIG. 4 illustrates a signalling diagram according to another example embodiment; and

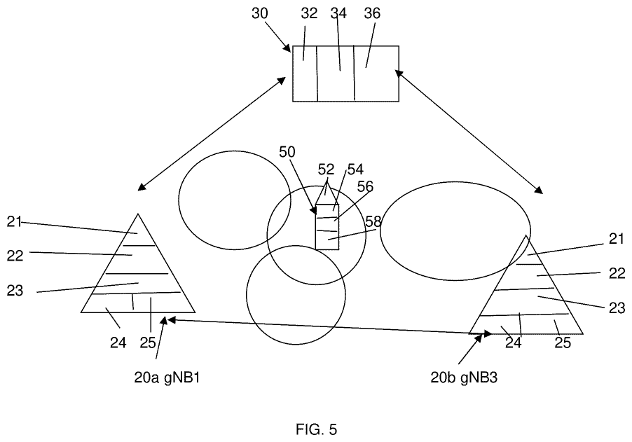

FIG. 5 illustrates a system according to an example embodiment.

### DETAILED DESCRIPTION

In current and future cellular systems, the configuration of active cells in a given geographical area is not fixed and may change. For example, events such as festivals could cause an influx of user equipment to a particular area which may result in the addition and/or creation of new cells to manage the additional user load. These additional cells may be controlled by one or more new gNBs that are different to the gNBs controlling the existing cells. Another scenario where cells may switch between an active state and an inactive state is for energy saving purposes. For example, cells may be turned on or turned off to optimize energy consumption, potentially leveraging machine learning concepts.

From a gNB perspective, this may result in the number and identity of neighboring cells to the cells the gNB is controlling changing frequently, i.e., there may be frequent changes to the neighbor cell relation table (NCRT) for each of the cells the gNB is controlling. Furthermore, the (backhaul Xn) connection to any new gNBs controlling the newly added cells will not be available as the involved gNBs are not aware of each other's transport network layer (TNL) addresses. As a result, a handover from one cell to another could suffer from a large latency.

In TS 38.423 “Xn application protocol”, the messages “Xn setup request” and “Xn setup response” (Sec. 8.4.1.2.) enable two gNBs to exchange the complete list of cells they are serving (served cell information NR IE). Additionally, the message “NG-RAN node configuration update” (Sec. 8.4.2.2.) allows this information to be updated. However, a prerequisite for updating this information is that the gNBs know each other's transport network layer (TNL) addresses, i.e., they have established Xn connectivity. Furthermore, this messaging is inefficient because a gNB can control up to 16384 cells and sending information about all those cells may not be relevant or necessary for the other gNBs.

In TS 38.300 “NR and NG-RAN overall description”, if a source gNB obtains the new radio cell global identifier (NR CGI) of a neighboring cell via user measurements, it may contact the access and mobility management function (AMF) to obtain the TNL address of the target gNB controlling the neighboring cell. The whole procedure consists of four steps with the AMF acting as a relay (Sec. 15.3.4.):
1. The source gNB contacts the AMF for the TNL of the target gNB, providing the NR CGI of the neighboring cell (or directly providing the target gNB if it's able to retrieve it from the NR CGI);
2. The AMF contacts the target gNB with a TNL address request;
3. The target gNB replies to the AMF with its TNL address; and
4. The AMF forwards the TNL address of the target gNB to the source gNB.

This procedure is lengthy and may result in delays in any future handover between the source gNB and the target gNB. Furthermore, the process involves a core network (CN) function which may not be necessary.

Regarding cell deletion, LTE 1685 “Neighbor relation robustness” supports gNB automatic deletion of the NCRT entries and of the corresponding Xn connections for those without ingoing and outgoing handovers based on configured time intervals. This time interval is in the order of minutes to hours. For example, a target gNB may be deleted from the NCRT if no handovers have been performed with that target gNB for a predetermined length of time.

FIG. 1 illustrates an example embodiment in which cells a to d are added (shown on the right-hand side) to the pre-existing network (shown on the left-hand side). The dashed lines show existing point-to-point (P2P) Xn connections. FIG. 1 shows that gNB 4 controlling cell a has no Xn connection to gNB 1 and gNB 2. Similarly, gNB 3 has no Xn connection to gNB 1.

Embodiments disclosed herein allow a given gNB to be informed of the addresses of gNBs controlling new neighboring cells in a timely manner. Therefore, a communication link between the gNBs can be established. Some example embodiments assume a service-based interface (SBI) connecting the gNB(-central units) to each other and to a RAN network repository function (NRF). Corresponding services, namely, subscription rights and notification about events/updates are defined that allow the source gNB controlling a given cell to be directly notified when a neighboring cell controlled by a target gNB has become active along with the address of the target gNB without going through the core network and in a reduced number of steps. Similarly, the source gNB may be directly notified when the neighboring cell is turned off by the target gNB without having to wait for the currently defined (time) counters to go off to remove the cell from the NCRT.

In such embodiments of a service-based architecture (SBA), there is no P2P Xn connections between the gNBs. Rather, the gNBs have predefined addresses for communication, such as IP addresses, and are conceptually connected via the same SBI bus. It will be appreciated that careful selection of the gNBs which need to be notified of certain events is required. For example, in FIG. 1, gNB3 does not need to be notified that gNB4 is now controlling cell a in FIG. 1 because gNB3 does not control any cells neighbouring cell a and so no handovers are required between gNB3 and gNB4. In this example, only gNB1 and gNB2 need to be notified that gNB4 is controlling cell a. Similarly, only gNB1 and gNB2 need to be notified that gNB3 is now controlling cell c. While gNB 3 can directly contact gNB 2 using the message “NG-RAN node configuration update” to inform it of this, there are no means for it to contact gNB1 directly in known setups to provide it with this information.

In example embodiments, in an initial registration step, the gNBs report their list of served cells to a RAN NRF only. This is in contrast to known arrangements where this information is potentially shared with multiple gNBs every time during (Xn) connection setup. In example embodiments, any update in the list of served cells is also reported to the RAN NRF.

FIG. 2 shows a signalling diagram relating to the example scenario shown in FIG. 1 according to an example embodiment. In step S1, the gNB3 transmits a registration message to a central network node which, in this embodiment, is a RAN NRF. The registration message comprises a list of served cells associated with the gNB3 together with an address for communication of the gNB3 which, in this embodiment, is an IP address. Similarly, in step S2, gNB1 transmits a registration message comprising a list of cells controlled by gNB1 and the IP address of gNB1.

In step S3, gNB3 turns cell c on. In other example embodiments, this step comprises activating cell c, for example, activating cell c from a low power or standby mode in which no radio coverage is provided. In step S4, gNB3 transmits a registration update message to the NRF which comprises an indication of this change to the status of cell c. The registration update message further comprises a NR CGI of cell c.

In step S5, the source gNB, gNB1, receives an indication of a cell controlled by another network. In this example embodiment, gNB1 obtains the NR CGI of cell c via over the air user measurements. When gNB1 receives the NR CGI of the (neighboring) target cell, cell c, controlled by the target gNB, gNB3, via the user measurements, in step S6, gNB1 asks the NRF for an address for communication of gNB3, in this case the IP address. In other example embodiments, the address for communication of gNB3 is any network address enabling gNB1 to communicate with gNB3. Furthermore, in step S6, gNB1 subscribes to receive updates on the status of cell c by transmitting a request to receive updates on the status of cell c to the NRF. In the example embodiment of FIG. 2, gNB1 asks the NRF for subscription rights for events/updates concerning the target cell, cell c, in the same transmission as the request for the IP address of gNB3. It will be appreciated that these requests may be sent in separate transmissions.

In step S7, the NRF responds to gNB1 by providing the address for communication of gNB3 and additionally grants the source gNB, gNB1, the requested subscription rights. By subscribing to updates on the status of the target cell, gNB1 will automatically be informed whenever there is a change to the status of cell c, for example, whenever cell c is turned on or off.

As a result of the target gNB registering its list of served cells with the NRF, the information about the gNB controlling cell c (the target cell-target gNB association) is readily available from the NRF. Hence, the address for communication of cell c may be provided to gNB1 in two steps compared to the four steps of the state of the art when the source gNB discovers the target cell for the first time.

In response to the source gNB obtaining the address of the target gNB, in step S8, gNB1 stores the address for communication of gNB3 in a datastore of gNB1. In particular, in this example embodiment, gNB1 caches the IP address of gNB3.

In response to receipt from the NRF of the subscription rights or an acknowledgement of the subscription of gNB1 to updates relating to cell c, in step S9, gNB1 subscribes directly to gNB3 by transmitting a request for updates on cell c to gNB3. After the source gNB subscribes to the desired cell updates with the target gNB, gNB3 will transmit updates regarding a change to a status of cell c directly to gNB1. For example, the address of gNB3 may be sent directly by gNB3 to the gNB1 in a single step only at a later point in time as discussed below.

In step S10, gNB3 turns off cell c after a period of time, for example, due to a reduced user load. It will be appreciated that gNB3 may be configured to deactivate cell c in other ways such that no radio coverage is provided by cell c. For example, cell c may be controlled to enter a low power mode.

In step S11, gNB3 transmits an indication of the deactivation of cell c to the NRF in a registration update message. In step S12, gNB3 transmits an indication of the deactivation of cell c to gNB1 because gNB1 is subscribed to updates on cell c. Steps S11 and S12 may occur simultaneously or at different times.

In step S13, in response to receipt of the indication that cell c is no longer active, gNB1 removes the IP address for gNB3 from its datastore to free up memory. In this way, the IP address can be removed from the datastore of gNB1 without having to wait for the expiry of a predetermined time period during which no handovers must take place as per the state of the art. It will be appreciated that the deletion of the IP address of gNB3 from the datastore of gNB1 after the expiry of a predetermined time if no handovers have been performed to cell c (or to a cell controlled by gNB3) may still be implemented in the example embodiments disclosed herein.

In some example embodiments, gNB1 may determine whether gNB3 controls any other cells it is configured to receive updates for. If there are no other cells controlled by gNB3 which gNB1 is configured to receive updates on, the IP address for gNB3 is deleted. If gNB1 is configured to receive updates on one or more other cells controlled by gNB3, gNB1 may choose not to delete the IP address of gNB3.

In some example embodiments, gNB1 is configured to store an indication of the association between gNB3 and cell c. For example, gNB1 may store the tuple (NR CGI of cell c, IP address of gNB3). In response to receipt of the indication that cell c is no longer active, gNB1 may remove from its data store the indication of the association between gNB3 and cell c. This way, any indications of associations between gNB3 and other cells will not be affected.

In step S14, gNB3 turns cell c on again after some time has elapsed. Now that cell c is active again, it provides radio coverage within the communications network. In step S15, gNB3 transmits an indication of the activation of cell c to the NRF in a registration update message. In step S16, gNB3 transmits an indication of the activation of cell c to gNB1 because gNB1 is subscribed to updates on cell c. This transmission further includes the IP address of gNB3 allowing gNB1 to once again store the IP address of gNB3 in its datastore without having to contact the NRF. In this particular example embodiment, gNB1 stores an indication of the association between cell c and gNB3. For example, gNB1 may store the tuple (NR CGI of cell c, IP address of gNB3). This allows gNB1 to know that gNB3 is controlling cell c.

FIG. 3 shows a signalling diagram relating to the example scenario shown in FIG. 1 according to another example embodiment. In this embodiment, the initial registration steps, steps S101 and S102, and the update of served cells, steps S103 and S104, are identical to steps S1, S2, S3 and S4 in FIG. 2. Similarly, gNB1 obtaining the CGI of cell c from user measurements in S105 is the same as S5 in FIG. 2.

In step S106, gNB1 transmits to the NRF a request for an address for communication of gNB3 controlling cell c, in particular, the IP address of gNB3. In contrast to FIG. 2, this transmission does not comprise a subscription request. Instead, the NRF maintains a register for the target cell, cell c, containing a list of gNBs which have asked for the IP address of the target gNB, gNB3, controlling the cell c. The NRF assumes those gNBs on the list are interested in receiving updates on cell c. For example, in step S107, the NRF updates the register to mark gNB1 as having requested the IP address of the gNB controlling cell c. Whenever there are updates regarding the target cell, cell c, the NRF notifies the gNBs on this list in the register of the updates as discussed below.

In step S108, in response to the request for the IP address from gNB1, the NRF transmits the IP address of gNB3 to gNB1. In response to receipt of the IP address, in step S109, gNB1 stores the address in its database, in this case, caching the address.

In steps S110 and S111, gNB3 turns cell c off after some time has elapsed and transmits an indication of this change to the NRF in a registration update message.

The NRF determines from the register that gNB1 should be relayed any updates regarding cell c from gNB3. Thus, in step S112, the NRF transmits an indication that cell c is no longer active to gNB1. In response, in step S113, gNB1 removes the IP address of gNB3 from its datastore.

In some example embodiments, gNB1 may determine whether gNB3 controls any other cells it is configured to receive updates for. If there are no other cells controlled by gNB3 which gNB1 is configured to receive updates on, the IP address for gNB3 is deleted. If gNB1 is configured to receive updates on one or more other cells controlled by gNB3, gNB1 may choose not to delete the IP address of gNB3.

In some example embodiments, gNB1 is configured to store an indication of the association between gNB3 and cell c. For example, gNB1 may store the tuple (NR CGI of cell c, IP address of gNB3). In response to receipt of the indication that cell c is no longer active, gNB1 may remove from its data store the indication of the association between gNB3 and cell c. This way, any indications of associations between gNB3 and other cells will not be affected.

In steps S114 and S115, gNB3 turns cell c on again after some time has elapsed and transmits an indication of this change to the NRF in a registration update message.

In step S116, the NRF determines from the register that gNB1 should be relayed any updates regarding cell c from gNB3. It also looks up the address for communication of gNB3 which controls cell c. In step S117, the NRF transmits to gNB1 an indication that cell c is now active together with the address for communication of gNB3. In response, gNB1 may once again store the address of gNB3 in its datastore. In this particular example embodiment, gNB1 stores an indication of the association between cell c and gNB3. For example, gNB1 may store the tuple (NR CGI of cell c, IP address of gNB3). This allows gNB1 to know that gNB3 is controlling cell c.

The example embodiment shown in FIG. 3 is beneficial in case a centralized handling of gNB addresses is desired. In this embodiment, fetching the address of the target gNB requires two steps in all cases compared to the four steps required in the state of the art.

In addition to the above-described service-based solutions, FIG. 4 shows a signalling diagram relating to the example scenario shown in FIG. 1 according to another example embodiment. This embodiment assumes the presence of a central network node, a network manager (NM), that is aware of all measurements in the system. As per 3GPP TS 32.432, the NM provides a package of end-user functions with the responsibility of the management of a network and has direct access to the Network Elements (e.g. gNBs). Performance measurements, as part of the performance management file and some other reports, are transferred to the NM. The performance measurements may relate to all cells controlled by a network node, a subset of the cells controlled by the network node, or to a specific cell controlled by the network node, e.g., cell c. The NM may therefore have all the information required to estimate the geographical area of coverage of each gNB even on the radio quality level. Based on each activation of a new cell in the given geographical area, the NM runs an algorithm to check for any new overlaps in the geographical area between the gNBs that currently have no (Xn/IP) established connectivity. Compared to the example embodiments described above, the establishment of new (Xn/IP) connectivity relationships between two gNBs can be performed much earlier for the first occurrence of the connection because it does not rely on a new cell being visible in an air user measurement, i.e. it doesn't rely on a user reporting the NR CGI of a target cell. On the other hand, some analytics is needed at the NM.

In step S1001 of FIG. 4, gNB3 turns cell c on. Then, gNB3 informs the MN that cell c is now active (not shown). In response, in step S1002, the NM transmits a request for performance measurements for cell c to gNB3. In response to this request, in step S1003, gNB3 transmits performance measurements for cell c back to the NM.

In step S1004, the NM looks up gNBs in the region of cell c. These may be gNBs controlling cells in the same geographical area as cell c. In the present example, the NM identifies gNB1, gNB2 and gNB4 as being in the region of cell c as can be seen in FIG. 1. In steps S1005, S1007 and S1009, the NM transmits a request for performance measurements to these gNBs. In response to the requests, in steps S1006, S1008 and S1010, gNB1, gNB2 and gNB4 transmit performance measurements for their served cells to the NM.

Utilising the performance measurements for cell c and the performance measurements for the cells served by gNB1, gNB2 and gNB4, in step S1011, the NM estimates the geographical coverage of the cells and determines which cells overlap and/or which cells are neighbors to cell c. Consequently, the NM determines that cell c is a neighbor to a cell controlled by gNB1 and gNB2 as can be seen in FIG. 1.

In step S1012, the NM transmits the address for communication of gNB3 to gNB1 such that gNB1 can establish the necessary connection with gNB3 for future handovers. Note that gNB3 and gNB2 already have an established communication link as shown in FIG. 1 and so there is no need to transmit the address for communication of gNB3 to gNB2.

In summary, some example embodiments relate to obtaining subscription rights to updates (turning on/off) of given target cells. The subscription rights are managed by a RAN NRF and are granted to the source gNB once it asks the RAN NRF for the address for communication of the target gNB which controls the target cell. In an example embodiment, the subscription rights are explicitly assigned by the RAN NRF to the source gNB, thereby allowing the target gNB to contact the source gNB directly with its address whenever necessary. In another example embodiment, subscription rights are implicit in the sense that the NRF is responsible for signaling the required updates to the source gNB after being informed of the updates itself by the target gNB. The number of steps required to obtain the address of the target gNB is thus two at most instead of four as in the state-of-the-art approach. This can avoid delays to handover procedures resulting in faster handovers. In another example embodiment, the source gNB is not required to receive an indication of a target cell controlled by a target gNB in order for the source and the target gNBs to establish a connection. Instead, a network manager is configured to look up gNBs in the geographical area of the target cell based on performance measurement reports for cell c received from the target gNB. The network manager may then obtain performance measurements for the cells controlled by the gNBs in the same geographical region as the target cell from which it can estimate which cells controlled by the gNBs overlap or neighbour the target cell and are therefore likely candidates for handovers to/from the target cell. In this case, the network manager sends the address of the target gNB controlling the target cell to the gNBs controlling neighbouring cells of the target cell where no such communication link is already established such that the gNBs can communicate during handover procedures. In this way, the gNB addresses may be exchanged without the need to wait for a user measurement report as per the previous embodiments.

FIG. 5 schematically shows a wireless communication network comprising two network nodes and a central network node according to an example embodiment. The apparatus of FIG. 5 may be configured to perform the procedures defined in the example embodiments described above. In FIG. 5 there are two network nodes gNB1 20a and gNB3 20b. Embodiments relate to the establishment of a communication link between the two network nodes that allows them to transmit signals between each other, for example, during a handover procedure.

The network nodes, gNB1 and gNB3, comprise transmitting circuitry 21 for transmitting signals to a user equipment 50, each other and a central network node 30. They also comprise receiving circuitry 22 for receiving signals from other network nodes.

The gNBs each comprise a datastore 24 for storing addresses for communication of other network nodes and updating circuitry 23 configured to update the information in the datastore by deletion or addition. The gNBs further comprise handover circuitry 25 configured to perform a handover procedure for a UE, such as UE 50, to another network node.

In this example embodiment, there is a central network node 30 that may comprise an NRF or NM which comprises a datastore 32 for storing the list of served cells of each network node, an indication as to whether these cells are active or inactive, and in some embodiments, a register of which network nodes require updates for certain cells. The central network node 30 also comprises transmitting and receiving circuitry 34 for transmitting signals to and receiving signals from the network nodes, such as gNBs 1 and 3. The central network node 30 may also comprise determination circuitry 36 configured to look up and/or estimate the geographical area covered by cells given the performance measurements for those cells.

User equipment 50 comprises: transmitting circuitry 52 and receiving circuitry 54 for transmitting and receiving signals to the different network nodes 20a, 20b; measuring circuitry 56 for detecting signals from cells and measuring radio link quality; and report generating circuitry 56 for generating measurement reports for transmission to a network node, such as gNB1. The measurement reports may include the global cell identifier of one or more detected cells and/or performance measurements for one or more detected cells.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

### LIST OF ABBREVIATIONS

Access and mobility management function (AMF)
Core network (CN)
New radio cell global identifier (NR CGI)
Network repository function (NRF)
Point-to-point (P2P)
Service-based architecture (SBA)
Service-based interface (SBI)
Transport network layer (TNL)

1.-26. (canceled)

27. A network node for supporting providing radio coverage within one or more cells of
a communication network, said network node comprising:
a datastore;
at least one processor; and
at least one memory storing instructions that when executed by the at least one processor cause the apparatus at least to perform:
in response to receipt from a user equipment of an indication of a cell controlled by another network node, transmitting to a central network node a request for an address for communication of said another network node;
in response to receipt from said central network node of said address for communication of said another network node, storing said address for communication of said another network node in said datastore; and
in response to receipt of an update on a status of said cell, updating said datastore accordingly.

28. The network node according to claim 27, wherein said update of said status of said cell comprises an indication that said cell is no longer active.

29. The network node according to claim 28, further caused to perform: in response to receipt of said indication that said cell is no longer active, determining whether said another network node controls any other active cells which said network node is configured to receive updates on, and where not, said updating said datastore comprises removing said address for communication of said another network node from said datastore.

30. The network node according to claim 27, wherein, when said update of said status of said cell comprises an indication that said cell has been activated and in response to receipt of said address for communication of said another network node, said updating said datastore comprises storing said address for communication of said another network node in said datastore.

31. The network node according to claim 27, wherein said update of said status of said cell is received from at least one of the following: said another network node and said central network node.

32. The network node according to claim 27, further caused to perform: in response to said receipt from said central network node of said address for communication of said another network node, transmitting to said another network node a request to receive updates on said status of said cell.

33. The network node according to claim 27, further caused to perform: in response to receipt from said user equipment of said indication of said cell controlled by said another network node, subscribing to receive updates on said status of said cell by transmitting to said central network node a request to receive updates on said status of said cell.

34. The network node according to claim 27, wherein said indication of said cell controlled by said another network node comprises a cell global identifier.

35. A network node for supporting providing radio coverage within one or more cells of a communication network, said network node comprising:
at least one processor; and
at least one memory storing instructions that when executed by the at least one processor cause the apparatus at least to perform:
in response to a change to a status of a cell of said one or more cells, registering said change to said status by transmitting to a central network node an indication of said change.

36. The network node according to claim 35, further caused to perform: activating said cell; and, when said cell has been activated, said indication of said change comprises an indication that said cell has been activated.

37. The network node according to claim 35, further caused to perform: deactivating said cell; and, when said cell has been deactivated, said indication of said change comprises an indication that said cell has been deactivated.

38. The network node according to claim 35, further caused to perform: in response to receipt from another network node of a request for updates on a status of said cell, transmitting said indication of said change to said another network node.

39. The network node according to claim 35, further caused to perform: transmitting to said central network node a registration message comprising at least one of the following: an address for communication of said network node and a list of cells controlled by said network node.

40. A central network node of a communication network, said central network node being configured to maintain a register of addresses for communication of network nodes within said communication network and a list of cells controlled by said network nodes within said communication network, said central network node comprising:
a datastore comprising said register;
at least one processor; and
at least one memory storing instructions that when executed by the at least one processor cause the apparatus at least to perform:
in response to receipt from a network node of a registration message comprising at least one of the following: an address for communication of a respective network node and a list of cells controlled by said network node, updating said register accordingly; and
in response to receipt from a first network node of a request for an address for communication of a second network node controlling a cell of said communication network identified by said first network node, transmitting to said first network node an indication of said address for communication of said second network node.

41. The central network node according to claim 40, further caused to perform: in response to receipt from said second network node of an indication of a change to a status of said cell, updating said register accordingly.

42. The central network node according to claim 41, wherein said change comprises an activation of said cell and said updating said register comprises marking said cell as active.

43. The central network node according to claim 41, wherein said change comprises a deactivation of said cell and said updating said register comprises marking said cell as inactive.

44. The central network node according to claim 41, further caused to perform: in response to said receipt of said request for said address for communication, marking said first network node as having requested said address for communication of said second network node in said register and relaying to said first network node any indications of changes of said status of said cell received from said second network node.
